(19) United States
(12) Patent Application Publication
(10) Pub. No.: US 2018/0287146 A1
(43) Pub. Date: Oct. 4, 2018

(54) LITHIUM POWDER, LITHIUM ION SECONDARY BATTERY NEGATIVE ELECTRODE USING THE SAME, AND LITHIUM ION SECONDARY BATTERY USING THE LITHIUM ION SECONDARY BATTERY NEGATIVE ELECTRODE

(71) Applicant: TDK CORPORATION, Tokyo (JP)

(72) Inventors: Hisashi SUZUKI, Tokyo (JP); Yuji YAMAMOTO, Tokyo (JP); Naoki KUBOTA, Tokyo (JP); Yukiko HIRABAYASHI, Tokyo (JP)

(73) Assignee: TDK CORPORATION, Tokyo (JP)

(21) Appl. No.: 15/939,882

(22) Filed: Mar. 29, 2018

(30) Foreign Application Priority Data
Mar. 31, 2017 (JP) 2017-069978
Feb. 1, 2018 (JP) 2018-016166

(51) Int. Cl. H01M 4/36; H01M 4/38; H01M 4/48; H01M 4/58; H01M 10/0525

(52) U.S. Cl. CPC H01M 4/366; H01M 4/382; H01M 4/483; H01M 2004/027; H01M 4/58; H01M 10/0525; H01M 4/5825

(57) ABSTRACT

A lithium powder includes: a core of metallic lithium; and a coating layer coating a surface of at least a part of the core. The coating layer contains lithium carbonate including a surface in at least a part of which lithium oxide is present. The coating layer may include a first coating film layer present in at least a part of the core, and a second coating film layer present in a surface of the first coating film layer. The first coating film layer may contain lithium carbide. The second coating film layer may contain lithium carbonate.

### CROSS-REFERENCE TO RELATED APPLICATION

This application claims priority from Japanese Patent Application Nos. 2017-069978 filed on Mar. 31, 2017 and 2018-016166 filed on Feb. 1, 2018 with the Japan Patent Office, the entire contents of which are hereby incorporated by reference.

### BACKGROUND

### 1. Technical Field

The present disclosure relates to a lithium powder, a lithium ion secondary battery negative electrode using the same, and a lithium ion secondary battery using the lithium ion secondary battery negative electrode.

### 2. Description of the Related Art

Lithium ion secondary batteries are being used as a power supply for various products, such as portable electronic devices, electric tools, drones, and xEVs, and as a ESS (Energy Storage System). As the products become smaller and are equipped with higher levels of functionality, there is a demand for a further increase in the energy density of the lithium ion secondary battery as a power supply for the various products.

Currently, as a negative electrode active material for the lithium ion secondary battery, carbon materials such as graphite are often used. In recent years, in order to achieve higher energy density, a number of alloy-based negative electrode active materials have been considered, such as Si, SiOₓ, and Sn, that have greater discharge capacity than graphite.

However, graphite, Si, SiOₓ, Sn and the like have an irreversible capacity. This is a quantity related to a phenomenon in which lithium ions intercalated in the negative electrode active material are trapped by the negative electrode active material during charging, and fail to be deintercalated from the negative electrode active material during discharging. In order to reduce the irreversible capacity, various methods have been attempted, such as a method where, in the case of graphite, the degree of graphitization is increased. In another method, the irreversible capacity is reduced in advance. In this method, lithium and the negative electrode are contacted with each other to cause an electrochemical reaction between chemical species causing the irreversible capacity and lithium. The lithium used in this case may be in the form of lithium foil or lithium powder. A foil has the disadvantage that it is difficult to manufacture a thin lithium foil. A thin lithium foil also lacks mechanical strength and is easily cut, making the handling of the foil during manufacturing process difficult. On the other hand, a lithium powder has the advantage of being capable of easily and uniformly reacting with the negative electrode. However, a lithium powder has a large specific surface area compared with a lithium foil. Accordingly, a lithium powder easily reacts with moisture, nitrogen, carbon dioxide and the like in the environment of use, making the handling of the powder difficult.

JP-T-8-505440 discloses a surface-coated lithium powder which contains a lithium compound, where the lithium compound contains oxygen and hydrocarbon and is selected from lithium carbonate, lithium oxide, and lithium hydroxide. The surface-coated lithium powder having the structure is relatively resistant to a reaction with atmospheric components. The document indicates that the surface-coated lithium powder can be transferred through such ambient atmospheres from one container to another without danger of ignition or loss of activity. JP-T-2010-507197 discloses a lithium powder having a surface coated with wax and inorganic coating. The material of the inorganic coating is selected from the group consisting of lithium carbonate, LiF, Li₃PO₄, SiO₂, Li₄SiO₄, LiAlO₂, Li₂TiO₃, and LiNbO₃. JP-T-2010-535936 discloses a method for providing a stable lithium powder, the method including (a) a step of heating a lithium powder to a temperature above the melting point thereof to obtain a molten lithium metal; (b) a step of dispersing the molten lithium metal; and (c) a step of contacting the dispersed molten lithium metal with a phosphorus-containing compound to obtain a substantially continuous protective layer of lithium phosphate on the lithium powder.

### SUMMARY

A lithium powder includes: a core of metallic lithium; and a coating layer coating a surface of at least a part of the core. The coating layer contains lithium carbonate including a surface in at least a part of which lithium oxide is present.

### BRIEF DESCRIPTION OF THE DRAWINGS

FIG. 1 is a schematic cross sectional view of a lithium ion secondary battery according to the present embodiment; and

FIG. 2 is a flowchart of a lithium powder manufacturing method according to the present embodiment.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

With the techniques disclosed in JP-T-8-505440, JP-T-2010-507197, and JP-T-2010-535936, storage stability of the lithium powder in the atmosphere cannot be increased sufficiently.

An object of the present disclosure is to provide a lithium powder having excellent atmospheric storage stability, a lithium ion secondary battery negative electrode using the same, and a lithium ion secondary battery using the negative electrode.

The lithium powder of the present embodiment is provided with a core of metallic lithium, and a coating layer coating at least a part of a surface of the core. The coating layer contains lithium carbonate. Lithium oxide is present in at least a part of the surface of the lithium carbonate.

That at least a part of the surface of the core is coated means, for example, that 50% or more and preferably 80% or more of the surface of the core is coated.

The lithium powder of the present embodiment has excellent storage stability in the atmosphere. In typical lithium powders, a coating film including lithium carbonate is present in the surface of the metallic lithium of the core. On the other hand, in the lithium powder of the present embodiment, the coating layer on the surface of the lithium (core) contains lithium carbonate including a surface in at least a part of which lithium oxide is present. The reason why the lithium powder of the present embodiment has excellent storage stability is not necessarily clear. However, the lithium oxide reacts with moisture according to the following expression (1), and thereby becomes lithium hydroxide.

Thus, it is believed that moisture is suppressed from reaching the lithium of the core due to the reaction of lithium oxide with moisture. It is believed that by such mechanism, the atmospheric storage stability of the lithium powder is improved.

Li₂O +H₂O→2LiOH (1)

Preferably, the coating layer includes a first coating film layer present in at least a part of the core, and a second coating film layer present on the first coating film layer. The first coating film layer preferably contains lithium carbide. The second coating film layer preferably contains the lithium carbonate.

In the above configuration, the lithium powder has excellent storage stability in the atmosphere. While the reason is not necessarily clear, lithium carbide reacts with moisture, producing lithium hydroxide, according to the following expression (2). Thus, it is believed that due to the reaction of lithium carbide with moisture, moisture is suppressed from reaching the lithium in the core. Such mechanism is believed to be responsible for an improvement in the atmospheric storage stability of the lithium powder.

Li₂C₂+2H₂O→2LiOH+C₂H₂ (2)

The second coating film layer preferably contains lithium hydroxide.

The content of lithium hydroxide to the lithium powder as a whole is preferably in a range of from 0.01 mass % to 1 mass %.

The content of lithium metal in the lithium powder is preferably in a range of from 80 to 98 mass %.

In the above configuration of the lithium powder, by contacting the lithium powder with the negative electrode in advance, it becomes easier to cause an electrochemical reaction between the chemical species as a cause of irreversible capacity and lithium. Thus, it becomes easy to obtain an irreversible capacity reduction effect.

The thickness of the second coating film layer is preferably in a range of from 59 nm to 2060 nm.

In the above configuration, when the thickness of the coating film is in the above ranges, the coating film blocks atmospheric moisture, carbon dioxide, nitrogen, and the like, and a reaction between the lithium in the core and any of the above is suppressed. As a result, better atmospheric storage characteristics can be obtained.

The thickness of the first coating film layer is preferably in a range of from 1 nm to 10 nm.

In the above configuration, when the thickness of the first coating film layer is in the above range, the coating film blocks atmospheric moisture, carbon dioxide, nitrogen, and the like, and a reaction between the lithium in the core and any of the above is suppressed. As a result, better atmospheric storage characteristics can be obtained.

Preferably, the lithium oxide includes particles having a particle size in a range of from 1 nm to 2000 nm.

In the above configuration, when the particle size of the lithium oxide particle is in the above range, the particles block atmospheric moisture, carbon dioxide, nitrogen, and the like, and a reaction between the lithium in the core and any of the above is suppressed. As a result, better atmospheric storage characteristics can be obtained.

Preferably, the lithium oxide has a form of a layer having a thickness in a range of from 1 nm to 2000 nm.

In the above configuration, when the thickness of the lithium oxide layer is in the above range, the coating film blocks atmospheric moisture, carbon dioxide, nitrogen, and the like, and a reaction between the lithium in the core and any of the above is suppressed. As a result, better atmospheric storage characteristics can be obtained.

By doping lithium ions using the lithium powder, the lithium ion secondary battery negative electrode according to the present embodiment is obtained.

The lithium ion secondary battery according to the present embodiment is provided with the lithium ion secondary battery negative electrode, the electrolyte, and the positive electrode, for example.

According to the present embodiment, a lithium powder having excellent atmospheric storage stability, a lithium ion secondary battery negative electrode using the same, and a lithium ion secondary battery using the same can be obtained.

In the following, preferred embodiments of the present disclosure will be described in detail with reference to the drawings. The dimensional ratios in the drawings are illustrative and not intended to be limiting.

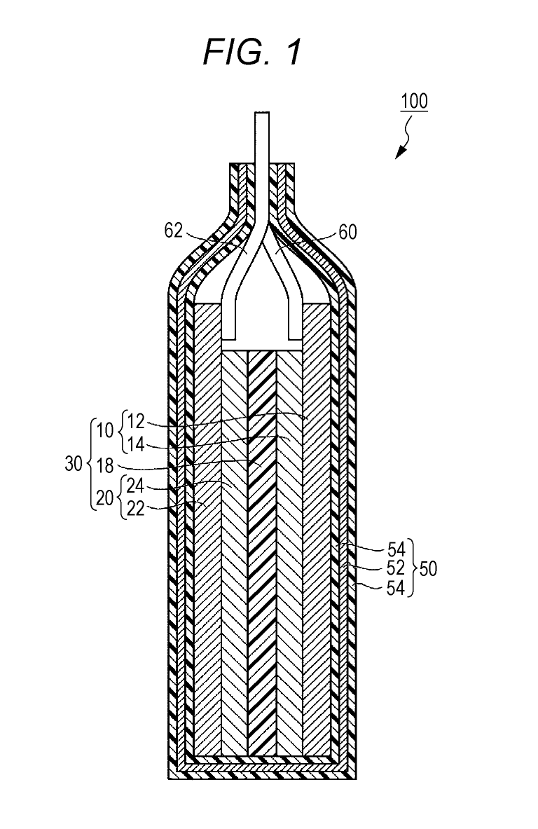

Referring to FIG. 1, a case will be described in which the electrode is an electrode for use in a lithium ion secondary battery. FIG. 1 is a schematic cross sectional view of a lithium ion secondary battery 100 according to the present embodiment.

### (Lithium Ion Secondary Battery)

The lithium ion secondary battery 100 mainly includes a stacked body 30, a case 50, and a pair of terminals 60, 62 connected to the stacked body 30. The case 50 includes an electrolyte, and houses the stacked body 30 in a sealed state.

In the stacked body 30, a pair of positive electrode 10 and negative electrode 20 is arranged in an opposing manner across a separator 18. The positive electrode 10 includes a plate-shaped (foil-shaped) positive electrode current collector 12, and a positive electrode mixture layer 14 disposed on the positive electrode current collector 12. The negative electrode 20 includes a plate-shaped (foil-shaped) negative electrode current collector 22, and a negative electrode mixture layer 24 disposed on the negative electrode current collector 22. The positive electrode mixture layer 14 and the negative electrode mixture layer 24 are in contact with the respective sides of the separator 18. The terminals 60, 62 are connected to respective end portions of the positive electrode current collector 12 and the negative electrode current collector 22. The terminals 60, 62 have end portions extending out of the case 50.

In the following, the positive electrode 10 and the negative electrode 20 may be collectively referred to as the electrode; the positive electrode current collector 12 and the negative electrode current collector 22 may be collectively referred to as the current collector; and the positive electrode mixture layer 14 and the negative electrode mixture layer 24 may be collectively referred to as the mixture layer.

The positive electrode 10 and the negative electrode 20 will be specifically described.

### (Positive Electrode)

The positive electrode 10 includes the plate-shaped (foil-shaped) positive electrode current collector 12 and the positive electrode mixture layer 14 disposed on the positive electrode current collector 12.

### (Positive Electrode Current Collector)

Preferably, the material of the positive electrode current collector 12 is an electronically conductive material that is resistant to oxidation during charging and has high corrosion resistance. Examples of the material of the positive electrode current collector 12 include metal foils of aluminum, stainless steel, nickel, and the like, and electrically conductive resin foils.

### (Positive Electrode Mixture Layer)

The positive electrode mixture layer 14 includes a positive electrode active material, a binder, and a conductive auxiliary agent.

### (Positive Electrode Active Material)

The positive electrode active material is not particularly limited, provided that the material is capable of reversibly undergoing absorption and desorption, or intercalation and deintercalation, of lithium ions, or doping and undoping of counter anions of the lithium ions (such as PF₆⁻, BF₄⁻, or ClO₄⁻). As the positive electrode active material, a positive electrode active material used in known lithium ion secondary batteries may be used. Examples of the positive electrode active material include lithium-containing metal oxides and lithium-containing metal phosphorus oxides. Examples of the lithium-containing metal oxides include lithium cobaltate (LiCoO₂), lithium nickelate (LiNiO₂), lithium manganese spinel (LiMn₂O₄), mixed metal oxides expressed by the general formula LiNiₓCo_{y}Mn_{z}O₂ (x+y+z=1), lithium vanadium compounds (LiVOPO₄, Li₃V₂(PO₄)₃), olivine-type LiMPO₄ (where M is Co, Ni, Mn, or Fe), and lithium titanate (Li₄Ti₅O₁₂).

By doping the negative electrode with lithium ion in advance, it becomes also possible to use a positive electrode active material that does not contain lithium. Examples of such positive electrode active material include lithium-free metal oxides (such as MnO₂ and V₂O₅), lithium-free metal sulfides (such as MoS₂ and TiS₂), and lithium-free fluorides (such as FeF₃ and VF₃).

### (Binder)

A binder is added to the positive electrode mixture layer in order to achieve adhesion of the positive electrode active material, adhesion between the positive electrode active material and the conductive auxiliary agent, and adhesion between the positive electrode active material and the current collector. Preferably, the binder has the characteristics of being not dissolvable in electrolytic solution, oxidation-resistant, and capable of exhibiting good adhesion. Examples of the binder used in the positive electrode mixture layer include polyvinylidene fluoride (PVDF) or copolymers thereof, polytetrafluoroethylene (PTFE), polyamide (PA), polyimide (PI), polyamide-imide (PAI), polybenzimidazole (PBI), polyether sulfone (PES), polyacrylic acid (PAA) and copolymers thereof, metal ion cross-linked polymer of polyacrylic acid (PAA) and copolymers thereof, polypropylene (PP) or polyethylene (PE) including grafted carboxylic acid anhydride, and mixtures thereof. Among others, PVDF is particularly preferable for the binder.

The content of the binder in the positive electrode mixture layer 14 is not particularly limited. The content of the binder in the positive electrode mixture layer 14 with reference to a total mass of the positive electrode active material, the conductive auxiliary agent, and the binder is preferably in a range of from 1 mass % to 15 mass %, and more preferably in a range of from 1.5 mass % to 5 mass %. If the amount of binder is too little, it tends to become difficult to form a positive electrode having a sufficient adhesive strength. Binders are generally electrochemically inactive, and hardly contribute to discharge capacity. Thus, conversely, if the amount of binder is excessive, it tends to become difficult to obtain a positive electrode having sufficient volume or mass energy density.

### (Conductive Auxiliary Agent)

The conductive auxiliary agent is not particularly limited, and known conductive auxiliary agents may be used provided that the conductive auxiliary agent improves the electronic conductivity of the positive electrode mixture layer 14. Examples of the conductive auxiliary agent include carbon materials such as carbon black, carbon nanotube, and graphene; metal fine powders of copper, nickel, stainless steel, iron and the like; electrically conductive oxides such as ITO; and mixtures thereof.

The content of the conductive auxiliary agent in the positive electrode mixture layer 14 is also not particularly limited. Normally, when the conductive auxiliary agent is added to the positive electrode mixture layer 14, the content of the conductive auxiliary agent with reference to a total mass of the positive electrode active material, the conductive auxiliary agent, and the binder is preferably in a range of from 0.5 mass % to 20 mass %, and more preferably in a range of from 1 mass % to 5 mass %.

### (Negative Electrode)

The negative electrode 20 includes the plate-shaped (foil-shaped) negative electrode current collector 22, and the negative electrode mixture layer 24 disposed on the negative electrode current collector 22.

### (Negative Electrode Current Collector)

The negative electrode current collector 22 may include an electrically conductive plate material. Examples of the negative electrode current collector 22 include a metal foil of copper, aluminum, nickel, stainless steel, iron and the like, and an electrically conductive resin foil.

### (Negative Electrode Mixture Layer)

The negative electrode mixture layer 24 includes a negative electrode active material, a binder, and a required amount of conductive auxiliary agent.

### (Negative Electrode Active Material)

The negative electrode active material is not particularly limited provided that the material is capable of reversibly undergoing absorption and desorption of lithium ions, or intercalation and deintercalation of lithium ions. As the negative electrode active material, a negative electrode active material used in known lithium ion secondary batteries may be used. Examples of the negative electrode active material include carbon materials such as natural graphite, synthetic graphite, mesocarbon microbeads, mesocarbon fiber (MCF), cokes, glassy carbon, and organic compound calcined material; metals that can be combined with lithium, such as Si, SiOₓ, Sn, and aluminum; alloys thereof; composite materials of such metals and carbon materials; and oxides such as lithium titanate (Li₄Ti₅O₁₂) and SnO₂. In the following, Si and SiOₓ will be referred to as Si-based negative electrode active material.

The shape of the Si-based negative electrode active material is not particularly limited. When the Si-based negative electrode active material includes particles, the particles preferably have an average particle size of from several nm to 20-30 μm in light of the ease of electrochemical reaction (ease of intercalation or deintercalation of Li⁺ with respect to Si), the ease of processing into a thin film electrode (film with a thickness in a range of from several μm to several tens of μm), and the like. The average particle size herein refers to a volume average particle size based on a particle size distribution measurement by laser diffraction. The Si-based negative electrode active material may include nanowires or thin pieces. In the case of nanowires, the nanowires preferably have an average diameter in a range of from several nm to 20-30 μm, and preferably have an average length in a range of from several μm to 20-30 μm. In the case of thin pieces, their thicknesses are preferably in a range of from several nm to 20-30 μm, and their diameters are preferably in a range of from several μm to 20-30 μm. In the present embodiment, the average diameter or average length is determined from scanning electron microscope (SEM) observations.

The specific surface area of the Si-based negative electrode active material according to the Brunauer-Emmett-Teller method (BET method) is preferably in a range of from 0.5 to 100 m²/g and more preferably in a range of from 1 to 20 m²/g. When the specific surface area of the Si-based negative electrode active material is smaller than 0.5 m²/g, an electrochemical reaction (the ease of intercalation and deintercalation of Li⁺ with respect to Si) is less likely to occur. When the specific surface area of the Si-based negative electrode active material exceeds 100 m²/g, more binder is added than normal when the Si-based negative electrode active material is formed into an electrode. As a result, the capacity and energy per unit volume of the electrode are decreased.

The Si-based negative electrode active material may be either crystalline or non-crystalline (amorphous). An amorphous Si-based negative electrode active material may be fabricated by melt spinning, gas atomization, or the like.

Of the Si-based negative electrode active material, Si is an element with the atomic number of 14, and forms an alloy with lithium.

Si forms alloys with various elements. In the negative electrode active material according to the present embodiment, the Si alloy may be any Si alloy. Examples of the element that forms an alloy with Si include Ba, Mg, Al, Ca, Ti, Sn, V, Cr, Mn, Fe, Co, Ni, Cu, Zn, Ge, Y, Zr, Nb, Mo, Ba, W, and Au.

The Si alloy may be an intermetallic compound, such as silicide that produces a compound with Si at specific proportions. Examples of silicide include Mg₂Si, Ca₂Si, CaSi₂Al₂, TiSi₂, Ti₅Si₃, VSi₂, FeSi₂, CoSi₂, Nb₃Ni₂Si, MoSi₂, Mo₃Si, Mo₅Si₃, and Mo₅SiB₂.

SiOₓ includes a SiO₂ matrix and fine, nanosized Si clusters dispersed in the matrix.

For example, the Si composite material includes Si, Si alloy, or SiOₓ particles with the surface coated with an electrically conductive material, such as carbon material, Al, Ti, Fe, Ni, Cu, Zn, Ag, or Sn. Examples of the Si composite material include a material including Si particles with the surfaces coated with carbon material to a thickness of several nm; a material including Si particles with the surfaces coated with graphite powder with a particle diameter of several μm; and a material including Si particles with the surfaces coated with carbon nanotube.

The amount of coating of carbon material is not particularly limited. The amount of coating of carbon material with respect to a total of the Si, Si alloy, or SiOₓ particles including the surfaces coated with the carbon material is preferably in a range of from 0.01 to 30 mass % and more preferably in a range of from 0.1 to 20 mass %. When the amount of coating of carbon material is not less than 0.01 mass %, sufficient electrical conductivity can be maintained. As a result, the cycle characteristics of the resultant lithium ion secondary battery negative electrode active material can be improved. If the amount of coating of carbon material exceeds 30 mass %, the ratio of carbon material to the active material as a whole would be excessive, and the discharge capacity would be decreased.

The method for coating the surface of the Si, Si alloy, or SiOₓ particles with the electrically conductive material is not particularly limited. Examples of the method include mechanical alloying, chemical vapor deposition, wet process, and a method by which the surface is coated with a polymer and then carbonization by thermal decomposition is performed.

### (Lithium Powder)

The manufacturing of lithium powder is performed in a glove box which has a low dew point (such as −99° C.) and low oxygen concentration (such as 1 ppm) and in which argon gas is circulated. The glove box is fitted with an adsorption tower for adsorbing moisture, and an adsorption tower for adsorbing oxygen respectively. Thus, the dew point and oxygen concentration in the glove box can be independently controlled. The adsorption towers are internally filled with zeolite that mainly adsorbs moisture or zeolite that mainly adsorbs oxygen. Examples of the zeolite that mainly adsorbs moisture and the zeolite that mainly adsorbs oxygen include Zeorum A-3 and SA-600A, respectively, from Tosoh Corporation. In the glove box, a stainless steel reaction container for manufacturing lithium powder is installed. The reaction container is temperature-controllable. In the reaction container, an impeller for agitating a reaction solution therein is installed. The top of the reaction container is provided with a lid. The lid has a hole for passing the impeller column, and supply openings for carbon dioxide gas and oxygen gas for forming a coating layer.

The shape of the lithium powder is not particularly limited. Preferably, from the viewpoint of weighing accuracy and lithium powder packing rate, the shape of the lithium powder is preferably substantially spherical. The average particle size, from the viewpoint of ease of handling, weighing accuracy, ease of an electrochemical reaction (ease of absorption or intercalation of Li⁺ with respect to the negative electrode active material), safety, and the like, is preferably in a range of from 1 μm to 100 μm and particularly preferably in a range of from 5 to 50 μm.

According to the present embodiment, the average particle size of the lithium powder means an average particle size as observed by an optical microscope or a SEM. The average particle size is calculated in terms of equivalent circle diameter. The equivalent circle diameter refers to the diameter of a circle with an area equal to the projected area of the particle, and is D determined by the following expression (3). The equivalent circle diameters of 200 lithium powders were measured, and the average value of the 200 measurements was considered the average particle size of the lithium powder. For the measurement of the average particle size, the image analysis software NS2K-Pro from Nanosystem Corporation was used. The lithium powder, when reacted with atmospheric moisture, nitrogen, and carbon dioxide, easily undergoes changes in particle diameter or form. Accordingly, during the measurement of the particle size of the lithium powder, exposure of the lithium powder to the atmosphere is avoided.

πD²/4=S (3)

where S is the projected area of the lithium powder.

The lithium powder according to the present embodiment may be effective when used with respect to a negative electrode active material such that many of the lithium ions absorbed or intercalated in the negative electrode active material during charging are not released or deintercalated during discharging. The technique according to the present embodiment may be particularly effective when Si, Si alloy, SiOₓ, Si composite material, tin, tin alloy, or the like is used as the negative electrode active material.

The lithium powder of the present embodiment is provided with a core of metallic lithium, and a coating layer coating at least a part of a surface of the core. The coating layer contains lithium carbonate. Lithium oxide is present in at least a part of the surface of the lithium carbonate.

The lithium powder of the present embodiment has excellent storage stability in the atmosphere. In typical lithium powders, a coating film including lithium carbonate is present in the surface of the metallic lithium of the core. On the other hand, in the lithium powder of the present embodiment, the coating layer on the surface of the lithium (core) contains lithium carbonate including a surface in at least a part of which lithium oxide is present. The reason why the lithium powder of the present embodiment has excellent storage stability is not necessarily clear. However, the lithium oxide reacts with moisture according to the following expression (4), and thereby becomes lithium hydroxide.

Thus, it is believed that moisture is suppressed from reaching the lithium of the core due to the reaction of lithium oxide with moisture. It is believed that by such mechanism, the atmospheric storage stability of the lithium powder is improved.

Li₂O+H₂O→2LiOH (4)

Lithium powder reacts with moisture, carbon dioxide, and nitrogen, and the like at room temperature, producing lithium hydroxide, lithium carbonate, and lithium nitride, respectively. When the reaction occurs, the content of lithium metal in the lithium powder is decreased. Storage stability is evaluated using the content of lithium metal in the lithium powder determined by measuring the lithium powder by thermal analysis, i.e., differential scanning calorimetry (DSC). The melting point of lithium metal is 180.54° C., and the heat of fusion of lithium metal is 3.00 KJ/mol. According to the following expression (5), the content of lithium metal in the lithium powder is computed.

Content of lithium metal (%)=Heat of fusion of sample (KJ)/(mass of sample (g)/6.941 (g/mol)×3.00 (KJ/mol))×100 (5)

That the decrease in the content of lithium metal is small when the lithium powder was stored in a certain humidity-controlled environment indicates excellent storage stability. The following expression (6) indicates a difference in the content of lithium metal before and after storage in the moist atmosphere. It may be considered that the smaller the difference, the better the lithium powder storage stability.

Difference in the content of lithium metal before and after storage in the moist atmosphere (%)=(content of lithium metal before storage in the moist atmosphere (%))−(content of lithium metal after storage in the moist atmosphere (%)) (6)

The surface and cross section of the lithium powder was observed using the scanning electron microscope (SEM) (SU8220 from Hitachi, Ltd). The cross section of the lithium powder was observed using a transmission electron microscope (TEM), specifically the analytical electron microscope JEM-2100F(HR) from JEOL Ltd. Lithium powder surface analysis was performed using the scanning X-ray photoelectron spectrometer (XPS) (PHIQuantera II from ULVAC-PHI, Inc.). By performing the observation of the cross section of the lithium powder using SEM or TEM, the thickness of a lithium carbonate layer, the particle size of lithium oxide particles, or the thickness of a lithium oxide layer can be analyzed. By a depth direction analysis using XPS, the presence or absence of lithium hydroxide, and the thickness of lithium carbide can be analyzed.

Preferably, the coating layer includes a first coating film layer present in at least a part of the core, and a second coating film layer present on the first coating film layer. The first coating film layer preferably contains lithium carbide. The second coating film layer preferably contains the lithium carbonate.

In the above configuration, the lithium powder has excellent storage stability in the atmosphere. While the reason is not necessarily clear, lithium carbide reacts with moisture, producing lithium hydroxide, according to the following expression (7). Thus, it is believed that due to the reaction of lithium carbide with moisture, moisture is suppressed from reaching the lithium in the core. Such mechanism is believed to be responsible for an improvement in the atmospheric storage stability of the lithium powder.

Li₂C₂+2H₂O→2LiOH+C₂H₂ (7)

The second coating film layer preferably contains lithium hydroxide.

The content of lithium hydroxide to the lithium powder as a whole is preferably in a range of from 0.01 mass % to 1 mass %.

The content of lithium metal in the lithium powder is preferably in a range of from 80 to 98 mass %.

In the above configuration of the lithium powder, by contacting the lithium powder with the negative electrode in advance, it becomes easier to cause an electrochemical reaction between the chemical species as a cause of irreversible capacity and lithium. Thus, it becomes easy to obtain an irreversible capacity reduction effect.

The thickness of the second coating film layer is preferably in a range of from 59 nm to 2060 nm. The thickness of the second coating layer is a sum of the thickness of the lithium carbonate layer and the particle size of the lithium oxide particle, or a sum of the thickness of the lithium carbonate layer and the thickness of the lithium oxide layer.

The thickness of the second coating film layer is more preferably in a range of from 59 nm to 1165 nm.

In the above configuration, when the thickness of the coating film is in the above ranges, the coating film blocks atmospheric moisture, carbon dioxide, nitrogen, and the like, and a reaction between the lithium in the core and any of the above is suppressed. As a result, better atmospheric storage characteristics can be obtained.

The thickness of the first coating film layer is preferably in a range of from 1 nm to 10 nm.

In the above configuration, when the thickness of the first coating film layer is in the above range, the coating film blocks atmospheric moisture, carbon dioxide, nitrogen, and the like, and a reaction between the lithium in the core and any of the above is suppressed. As a result, better atmospheric storage characteristics can be obtained.

Preferably, the lithium oxide includes particles having a particle size in a range of from 1 nm to 2000 nm.

Preferably, the lithium oxide includes particles having a particle size in a range of from 1 nm to 1100 nm.

In the above configuration, when the particle size of the lithium oxide particle is in the above range, the particles block atmospheric moisture, carbon dioxide, nitrogen, and the like, and a reaction between the lithium in the core and any of the above is suppressed. As a result, better atmospheric storage characteristics can be obtained.

Preferably, the lithium oxide has a form of a layer having a thickness in a range of from 1 nm to 2000 nm.

In the above configuration, when the thickness of the lithium oxide layer is in the above range, the coating film blocks atmospheric moisture, carbon dioxide, nitrogen, and the like, and a reaction between the lithium in the core and any of the above is suppressed. As a result, better atmospheric storage characteristics can be obtained.

By doping lithium ions using the lithium powder, the lithium ion secondary battery negative electrode according to the present embodiment is obtained.

The lithium ion secondary battery according to the present embodiment is provided with the lithium ion secondary battery negative electrode, the electrolyte, and the positive electrode, for example.

The negative electrode active material used in the negative electrode is as mentioned above.

The method for doping the lithium ion secondary battery negative electrode with lithium ions using the lithium powder is implemented as follows, for example. First, the lithium powder is supplied onto the negative electrode. Examples of the supply method to be used include typical powder supply methods, such as leveling supply, vibration supply, and electrostatic spray. Secondly, the negative electrode supplied with the lithium powder is pressed. This is implemented to immobilize the lithium powder on the negative electrode, and to improve the contact between the negative electrode and the lithium powder. By simply pressing, lithium ions can be doped into the lithium ion secondary battery negative electrode to some extent. The pressing may be implemented or may not be implemented. Thirdly, the negative electrode is combined with the other battery constituent elements, such as the positive electrode and the electrolyte to manufacture the battery. By adding the electrolyte, the lithium ions can be sufficiently doped into the lithium ion secondary battery negative electrode.

The lithium ion secondary battery according to the present embodiment is provided with the negative electrode for the lithium ion secondary battery, the electrolyte, and the positive electrode, for example.

### (Binder)

A binder is added to the negative electrode mixture layer in order to make the negative electrode active material and the negative electrode active material adhere to each other, make the negative electrode active material and the conductive auxiliary agent adhere to each other, and make the negative electrode active material and the current collector adhere to each other. The binder preferably has, for example, the characteristics of being not dissolvable or not becoming excessively swelled in the electrolytic solution, being resistant to reduction, and having good adhesion. Examples of the binder used in the negative electrode mixture layer include polyvinylidene fluoride (PVDF) or copolymers thereof; polytetrafluoroethylene (PTFE); polyamide (PA); polyimide (PI); polyamide-imide (PAI); polybenzimidazole (PBI); styrene butadiene rubber (SBR); carboxymethylcellulose; polyacrylic acid (PAA) and copolymers thereof; metal ion cross-linked polymer of polyacrylic acid (PAA) and copolymers thereof; polypropylene (PP) and polyethylene (PE) including grafted carboxylic acid anhydride; and mixtures thereof. Preferably, the binder may be polyamide-imide, among others. Polyimide is added as a precursor polyamic acid, and becomes polyimide through heat treatment after electrode formation.

The content of the binder in the negative electrode mixture layer 24 is not particularly limited. The content of the binder in the negative electrode mixture layer 24 with reference to a total mass of the negative electrode active material, conductive auxiliary agent and binder is preferably in a range of from 1 mass % to 15 mass % and more preferably in a range of from 3 mass % to 10 mass %. If the amount of binder is too small, it tends to become difficult to form a negative electrode having sufficient adhesive strength. The binder is generally electrochemically inactive, and therefore hardly contributes to discharge capacity. Thus, conversely, if the amount of binder is too large, it tends to become difficult to obtain a sufficient volume or mass energy density. The content of the conductive auxiliary agent in the negative electrode mixture layer 24 is also not particularly limited. When the conductive auxiliary agent is added to the negative electrode mixture layer 24, normally the content of the conductive auxiliary agent with respect to the active material is preferably in a range of from 0.5 mass % to 20 mass % and more preferably in a range of from 1 mass % to 12 mass %.

### (Conductive Auxiliary Agent)

The above-mentioned conductive auxiliary agent used in the positive electrode, such as carbon materials, may also be used in the negative electrode.

A method for manufacturing the electrodes 10, 20 according to the present embodiment will be described. According to the present embodiment, the method for manufacturing the electrodes 10, 20 includes a step of applying a paint including the active material, binder, and conductive auxiliary agent onto the current collector (which may be hereinafter referred to as “application step”); and a step of removing solvent from the paint applied to the current collector (which may be hereinafter referred to as “solvent removal step”).

### (Application Step)

The application step of applying the paint to the current collectors 12, 22 will be described. The paint includes the active material, binder, conductive auxiliary agent, and solvent. The mixing method and the order of mixing of the components of the paint, such as the active material, binder, conductive auxiliary agent, and solvent, are not particularly limited. For example, firstly to a mixture obtained by mixing the active material and the conductive auxiliary agent by dry blending, a solution (solvent) including the binder is added and mixed. In this way, the paint is prepared. The paint, which includes the above-mentioned active material, binder, conductive auxiliary agent, and solvent, is applied to the current collectors 12, 22. The application method is not particularly limited, and may include any of the methods normally adopted for fabricating an electrode. Examples of the application method include slit-die coating and doctor blade method.

### (Solvent Removal Step)

Subsequently, the solvent in the paint applied to the current collectors 12, 22 is removed. The removal method is not particularly limited. The removing may include drying the current collectors 12, 22 with the paint applied thereto at 60° C. to 150° C., for example. In this way, the mixture layers 14, 24 are formed on the current collectors 12, 22, respectively, whereby the positive electrode 10 and the negative electrode 20 are formed. Thereafter, the positive electrode 10 and the negative electrode 20 may be pressed, as needed, using a roll press device and the like. In this way, the electrode densities of the positive electrode 10 and the negative electrode 20 may be adjusted to desired values. The roll press may have a linear pressure in a range of from 100 to 2000 kgf/cm, for example.

Through the above steps, the electrodes according to the present embodiment can be fabricated.

Here, other constituent elements of the lithium ion secondary battery 100 using the electrodes fabricated as mentioned above will be described.

### (Electrolyte)

The electrolyte is contained in the positive electrode mixture layer 14, the negative electrode mixture layer 24, and the separator 18. The electrolyte is not particularly limited. For example, in the present embodiment, an electrolyte solution including a lithium salt (electrolyte solution using an organic solvent) may be used as the electrolyte. As the electrolyte solution, a nonaqueous solvent having a lithium salt dissolved therein (organic solvent) may be preferably used. Examples of the lithium salt that can be used include salts of LiPF₆, LiClO₄, LiBF₄, LiAsF₆, LiCF₃SO₃, LiC₂F₅SO₃, LiC(SO₂CF₃)₃, LiN(SO₂CF₃)₂, LiN(SO₂C₂F₅)₂, LiN(SO₂CF₃)(SO₂C₄F₉), LiN(COC₂F₅)₂, and LiBC₄O₈. The salts may be used each individually or in combination of two or more thereof.

Preferable examples of the organic solvent include propylene carbonate, ethylene carbonate, diethyl carbonate, dimethyl carbonate, methyl ethyl carbonate, fluoroethylene carbonate, difluoroethylene carbonate, diallyl carbonate, 2,5-dioxahexanedioic acid dimethyl, 2,5-dioxahexanedioic acid diethyl, furan, 2,5-dimethyl furan, tetrahydrofuran, 2-methyl tetrahydrofuran, tetrahydropyran, 1,3-dioxane, 1,4-dioxane, dimethoxymethane, dimethoxyethane, 1,2-diethoxyethane, diglyme, triglyme, tetraglyme, methyl acetate, acetic acid ethyl, propyl acetate, isopropyl acetate, butyl acetate, difluoromethyl acetate, ethyl trifluoroacetate, methyl propionate, ethyl propionate, propyl propionate, methyl formate, ethyl formate, ethyl butyrate, isopropyl butyrate, methyl isobutyrate, cyanomethyl acetate, vinyl acetate, γ-butyrolactone, γ-valerolactone, δ-valerolactone, ε-caprolactone, γ-hexanolactone, γ-undecalactone, trimethyl phosphate, triethyl phosphate, tri-n-propyl phosphate, trioctyl phosphate, triphenyl phosphate, methoxy-nonafluorobutane, ethoxy-nonafluorobutane, 1-methoxyheptafluoropropane, 2-trifluoromethyl-3-ethoxydodecofluorohexane, methyl nonafluorobutylether, and ethyl nonafluorobutylether. These may be used each individually or in combination of two or more thereof mixed at any ratios.

To the electrolyte, an additive may be added. Examples of the additive include an additive that produces a good solid electrolyte interface (SEI) on the surface of the negative electrode active material; an additive that produces a good SEI on the surface of the positive electrode active material; and an additive that has an over-charge suppressing effect. Specific examples of the additive include acetonitrile, propionitrile, succinonitrile, glutaronitrile, adiponitrile, pimelonitrile, suberonitrile, sebaconitrile, cyclohexylbenzene, fluorocyclohexylbenzene compound (1-fluoro-2-cyclohexylbenzene, 1-fluoro-3-cyclohexylbenzene, 1-fluoro-4-cyclohexylbenzene), tert-butylbenzene, tert-amylbenzene, 1-fluoro-4-tert-butylbenzene, biphenyl, terphenyl(o-, m-, p-isomers), diphenylether, fluorobenzene, difluorobenzene(o-, m-, p-isomers), anisole, 2,4-difluoroanisole, partial hydrides of terphenyl (1,2-dicyclohexylbenzene, 2-phenylbicyclohexyl, 1,2-diphenylcyclohexane, o-cyclohexylbiphenyl), methyl isocyanate, ethyl isocyanate, butyl isocyanate, phenyl isocyanate, tetramethylene diisocyanate, hexamethylene diisocyanate, octamethylene diisocyanate, 1,4-phenylene diisocyanate, 2-isocyanatoethyl acrylate, 2-isocyanatoethyl methacrylate, 2-propynylmethyl carbonate, 2-propynyl acetate, 2-propynyl formate, 2-propynyl methacrylate, 2-propynyl methanesulfonate, 2-propynyl vinylsulfonate, 2-propynyl 2-(methanesulfonyloxy) propionate, di(2-propynyl) oxalate, methyl 2-propynyl oxalate, ethyl 2-propynyl oxalate, di(2-propynyl) glutarate, 2-butyn-1,4-diyldimethanesulfonate, 2-butyn-1,4-diyl diformate, 2,4-hexadiyne-1,6-diyldimethanesulfonate, 1,3-propane sultone, 1,3-butanesultone, 2,4-butanesultone, 1,4-butanesultone, 1,3-propene sultone, 2,2-dioxide-1,2-oxathiolane-4-yl acetate, 5,5-dimethyl -1,2-oxathiolane-4-one 2,2-dioxide and other sultones, ethylene sulfite; hexahydrobenzo[1,3,2]dioxathiolane-2-oxide(which may also be referred to as 1,2-cyclohexane diol cyclic sulfite), 5-vinyl-hexahydro-1,3,2-benzodioxathiol-2-oxide and other annular sulfites, butane-2,3-diyldimethanesulfonate, butane-1,4-diyldimethanesulfonate, methylene methanedisulfonate and other sulfonic acid esters, divinyl sulfone, 1,2-bis(vinylsulfonyl)ethane, bis(2-vinylsulfonyl ethyl)ether, 1,3-propane sultone,1,-butanesultone, 1,4-butanesultone, 2,4-butanesultone, 1,3-propene sultone, 2,2-dioxide-1,2-oxathiolane-4-yl acetate, 5,5-dimethyl -1,2-oxathiolane-4-one 2,2-dioxide, methylene methanedisulfonate, 4-(methyl sulfonylmethyl)-1,3,2-dioxathiolane2-oxide, butane -2,3-diyldimethanesulfonate, butane -1,4-diyldimethanesulfonate, dimethyl methanedisulfonate, pentafluorophenylmethane sulfonate, divinyl sulfone, bis(2-vinylsulfonyl ethyl)ether, trimethyl phosphate, tributyl phosphate, trioctyl phosphate, tris phosphate (2,2,2-trifluoroethyl), bis(2,2,2-trifluoroethyl)methyl phosphate, bis(2,2,2-trifluoroethyl)ethyl phosphate, bis(2,2,2-trifluoroethyl)2,2-difluoroethyl phosphate, bis(2,2,2-trifluoroethyl)2,2,3,3-tetrafluoropropyl phosphate, bis(2,2-difluoroethyl)2,2,2-trifluoroethyl phosphate, bis(2,2,3,3-tetrafluoropropyl)2,2,2-trifluoroethyl phosphate, (2,2,2-trifluoroethyl)(2,2,3,3-tetrafluoropropyl) methyl phosphate, tris (1,1,1,3,3,3-hexafluoropropane-2-yl) phosphate, methyl methylene bisphosphonate, ethyl methylene bisphosphonate, methyl ethylene bisphosphonate, ethyl ethylene bisphosphonate, methyl butylene bisphosphonate, ethyl butylene bisphosphonate, methyl 2-(dimethylphosphoryl) acetate, ethyl 2-(dimethylphosphoryl) acetate, methyl 2-(diethylphosphoryl) acetate, ethyl 2-(diethylphosphoryl) acetate, 2-propynyl 2-(dimethylphosphoryl) acetate, 2-propynyl 2-(diethylphosphoryl) acetate, methyl 2-(dimethoxyphosphoryl) acetate, ethyl 2-(dimethoxyphosphoryl) acetate, methyl 2-(diethoxyphosphoryl) acetate, ethyl 2-(diethoxyphosphoryl) acetate, 2-propynyl 2-(dimethoxyphosphoryl) acetate, 2-propynyl 2-(diethoxyphosphoryl) acetate, methyl pyrophosphate, ethyl pyrophosphate, acetic anhydride, propionic anhydride, succinic anhydride, maleic anhydride, 2-allylsuccinic anhydride, glutaric anhydride, itaconic anhydride, 3-sulfopropionic anhydrides, methoxypentafluorocyclotriphosphazene, ethoxypentafluorocyclotriphosphazene, phenoxypentafluorocyclotriphosphazene, and ethoxyheptafluorocyclotetraphosphazene.

In the present embodiment, the electrolyte may be a gel electrolyte obtained by adding a gelling agent, instead of a liquid. Instead of an electrolyte solution, a solid electrolyte (electrolyte including solid polymer electrolyte or ion-conducting inorganic material) may be used.

### (Separator)

The separator 18 is an electrically insulating microporous film. Examples of the separator 18 include a single-layer microporous film or a stacked microporous film of a film including polyethylene, polypropylene, or other polyolefins; a microporous film of the polymer mixture film fabricated by dry process or wet process; and a nonwoven fabric including at least one configuration material selected from the group consisting of cellulose, polyester, polyethylene, and polypropylene. The separator 18 may also be a microporous film including glass fibers.

On one side or both sides of the separator, a heat-resistant layer may be formed. The heat-resistant layer may include inorganic particles of alumina and the like, and a binder. The binder may be the binder used in the positive electrode 10 or the negative electrode 20.

### (Case)

The case 50 seals therein the stacked body 30 and the electrolyte solution. The case 50 is not particularly limited provided that the case is configured to suppress, e.g., external leakage of the electrolytic solution and entry of external moisture and the like into the electrochemical device 100. For example, the case 50 may include a metal laminate film, as illustrated in FIG. 1. The metal laminate film includes a metal foil 52 and polymer films 54 coating the metal foil 52 from both sides. The metal foil 52 may include an aluminum foil and a stainless steel foil. The material of the outer polymer film 54 is preferably a high melting-point polymer (such as polyethylene terephthalate (PET) and polyamide). The material of the inner polymer film 54 is preferably polyethylene (PE), polypropylene (PP), and the like.

### (Terminal)

The terminals 60, 62 are formed from an electrically conductive material, such as aluminum or nickel.

By a known method, the terminals 60, 62 are respectively welded to the positive electrode current collector 12 and the negative electrode current collector 22. The separator 18 is sandwiched between the positive electrode mixture layer 14 of the positive electrode 10 and the negative electrode mixture layer 24 of the negative electrode 20. In this state, the positive electrode 10, the negative electrode 20, and the separator 18 are inserted into the case 50 together with the electrolyte, and then the opening portion of the case 50 is thermally sealed.

A preferred embodiment of the lithium powder, the lithium ion secondary battery negative electrode using the same, and the lithium ion secondary battery using the same has been described. However, the technology of the present disclosure is not limited to the embodiment.

For example, the negative electrode may be used in an electrochemical element other than a lithium ion secondary battery. For example, the negative electrode may be used in the negative electrode of a lithium ion capacitor. Such electrochemical devices may be used for purposes including portable telephones (including smartphone), notebook personal computers, digital cameras, electric tools, vehicles, and ESS (Energy Storage System).

### EXAMPLES

In the following, the present embodiment will be described more specifically with reference to examples and comparative examples. However, the technology of the present disclosure is not limited to the examples. Table 1 shows the lithium powder manufacturing conditions in the examples and the comparative examples. Table 2 shows the form and atmospheric storage stability of the lithium powders.

### <Preparation of Lithium Powder>

A lithium powder was fabricated by the following method and evaluated.

### Example 1

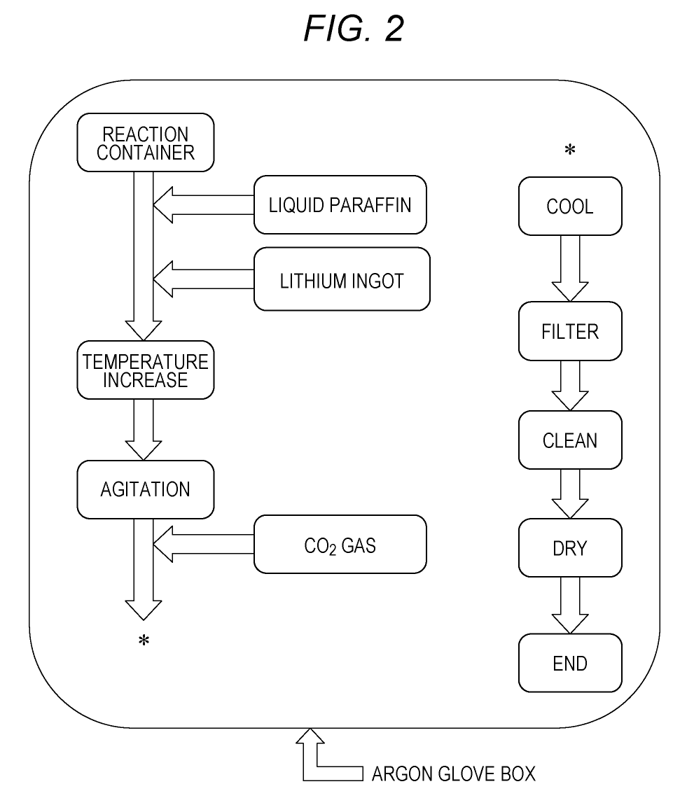

As shown in FIG. 2, the lithium powder was manufactured in a glove box in which argon gas was circulated and which had a dew point of −99° C. and an oxygen concentration of 0.01 ppm. Into a stainless steel container installed in the glove box, 6 L of liquid paraffin and 200 g of lithium ingot were loaded, and the container was closed with a stainless steel lid with an impeller. The stainless steel container was heated with a heater to raise the temperature of the liquid paraffin to 185° C., and lithium was melted. That is, the reaction solution temperature was 185° C. Then, the impeller was rotated for 15 minutes at 10,000 rpm. Subsequently, while the impeller was rotated at 10,000 rpm, carbon dioxide gas was initially supplied at an addition rate of 155 cm³/min for 240 seconds, and then oxygen gas was supplied at an addition rate of 1 cm³/min for 60 seconds. The carbon dioxide gas addition rate of 155 cm³/min is the rate of supply of the volume of the carbon dioxide gas per minute in a standard state, i.e., at 0° C. and 1 atmosphere. In this case, the amount of the carbon dioxide gas added was 155 cm³/min×4 min=620 cm³. The same applies to the case of oxygen gas. Thereafter, the rotation of the impeller was stopped, the solution was cooled until the reaction solution temperature became 50° C., and the solution was filtered using a filter (with a pore size of 2 μm). A lithium powder that remained on the filter was cleaned with hexane to thereby remove liquid paraffin from the lithium powder. The lithium powder was then transferred from the filter into a glass bottle. Further, the glass bottle was sealed in an aluminum laminate bag.

<Surface and Cross Sectional Observation, Surface Analysis, Particle Diameter Measurement, and Thermal Analysis with Respect to Lithium Powder>

The lithium powder manufactured in the present example had a lithium core with a lithium surface coated with a coating film of lithium carbonate (thickness 58 nm). The lithium powder further included a coating film containing lithium oxide particles (particle size 1 nm) on the surface of the lithium carbonate. The content of lithium metal was 90 mass %. The lithium powder had an average particle diameter of 25 μm. These results are shown in Table 2.

### <Lithium Powder Storage Stability>

In a dry room (temperature 23° C., dew point −50° C.), a desiccator was placed, and 500 cm³ of cesium fluoride saturated aqueous solution was put into the desiccator. Due to the vapor pressure of the aqueous solution, the relative humidity in the desiccator became 3.8%. In the following, this state will be referred to as moist atmosphere. On a perforated plate in the desiccator, a stainless steel tray was placed, and 1 g of lithium powder was put thereon and left to stand for three hours with the lid of the desiccator closed. A thermal analysis of the lithium powder indicated that the lithium powder had a lithium metal content of 88 mass %. Accordingly, the difference in the content of lithium metal before and after storage in the moist atmosphere (the content of lithium metal before storage in the moist atmosphere—the content of lithium metal after storage in the moist atmosphere) was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 2

In the examples other than Example 1 and in the comparative examples, lithium powder was manufactured as in Example 1 by controlling the dew point, carbon dioxide gas supply amount, oxygen gas supply amount, and reaction solution temperature as shown in Table 1.

In the present example, the lithium powder was manufactured in the same way as in Example 1 with the exception that the oxygen gas was supplied at an addition rate of 12 cm³/min for 60 seconds. The resultant lithium powder included, as in Example 1, a lithium core; a coating film of lithium carbonate coating the surface of the lithium (thickness 60 nm); and a coating film present on the surface of the lithium carbonate and containing lithium oxide particles (particle size 10 nm). The content of lithium metal was 92 mass %, and the average particle diameter of the lithium powder was 22 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 3

The lithium powder was manufactured in the same way as in Example 1 with the exception that the oxygen gas was supplied at an addition rate of 55 cm³/min for 60 seconds. The resultant lithium powder included, as in Example 1, a lithium core; a coating film of lithium carbonate coating the surface of the lithium (thickness 63 nm); and a coating film present on the surface of the lithium carbonate and containing lithium oxide particles (particle size 115 nm). The content of lithium metal was 90 mass %, and the average particle diameter of the lithium powder was 26 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 4

The lithium powder was manufactured in the same way as in Example 1 with the exception that the oxygen gas was supplied at an addition rate of 400 cm³/min for 60 seconds. The resultant lithium powder included, as in Example 1, a lithium core; a coating film of lithium carbonate coating the surface of the lithium (thickness 62 nm); and a coating film present on the surface of the lithium carbonate and containing lithium oxide particles (particle size 530 nm). The content of lithium metal was 89 mass %, and the average particle diameter of the lithium powder was 25 μm. The difference in the content of lithium metal before and after storage in the moist atmosphere was small and 3 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 5

The lithium powder was manufactured in the same way as in Example 1 with the exception that the oxygen gas was supplied at an addition rate of 700 cm³/min for 60 seconds. The resultant lithium powder included, as in Example 1, a lithium core; a coating film of lithium carbonate coating the surface of the lithium (thickness 65 nm); and a coating film present on the surface of the lithium carbonate and containing lithium oxide particles (particle size 1100 nm). The content of lithium metal was 88 mass %, and the average particle diameter of the lithium powder was 26 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 6

The lithium powder was manufactured in the same way as in Example 1 with the exception that the oxygen gas was supplied at an addition rate of 1300 cm³/min for 60 seconds. The resultant lithium powder included, as in Example 1, a lithium core; a coating film of lithium carbonate coating the surface of the lithium (thickness 60 nm); and a coating film present on the surface of the lithium carbonate and containing lithium oxide particles (particle size 2000 nm). The content of lithium metal was 87 mass %, and the average particle diameter of the lithium powder was 28 μm. The difference in the content of lithium metal before and after storage in the moist atmosphere was small and 1 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 7

The lithium powder was manufactured in the same way as in Example 1 with the exception that the oxygen gas was supplied at an addition rate of 400 cm³/min for 60 seconds, and that the reaction solution temperature was 200° C. The resultant lithium powder included, as in Example 1, a lithium core; a lithium carbide coating film (thickness 1 nm) coating the surface of the lithium; a coating film of lithium carbonate (thickness 62 nm) coating the surface of the lithium carbide; and a coating film present on the surface of the lithium carbonate and containing lithium oxide particles (particle size 500 nm). The content of lithium metal was 90 mass %, and the average particle diameter of the lithium powder was 22 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 8

The lithium powder was manufactured in the same way as in Example 1 with the exception that the oxygen gas was supplied at an addition rate of 400 cm³/min for 60 seconds, and that the reaction solution temperature was 210° C. The resultant lithium powder included, as in Example 1, a lithium core; a coating film of lithium carbide (thickness 3 nm) coating the surface of the lithium; a coating film of lithium carbonate (thickness 60 nm) coating the surface of the lithium carbide; and a coating film present on the surface of the lithium carbonate and containing lithium oxide particles (particle size 510 nm). The content of lithium metal was 92 mass %, and the average particle diameter of the lithium powder was 23 μm. The difference in the content of lithium metal before and after storage in the moist atmosphere was small and 3 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 9

The lithium powder was manufactured in the same way as in Example 1 with the exception that the oxygen gas was supplied at an addition rate of 400 cm³/min for 60 seconds, and that the reaction solution temperature was 220° C. The resultant lithium powder included, as in Example 1, a lithium core; a coating film of lithium carbide (thickness 6 nm) coating the surface of the lithium; a coating film of lithium carbonate (thickness 61 nm) coating the surface of the lithium carbide; and a coating film present on the surface of the lithium carbonate and containing lithium oxide particles (particle size 520 nm). The content of lithium metal was 91 mass %, and the average particle diameter of the lithium powder was 21 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 10

The lithium powder was manufactured in the same way as in Example 1 with the exception that the oxygen gas was supplied at an addition rate of 400 cm³/min for 60 seconds, and that the reaction solution temperature was 230° C. The resultant lithium powder included, as in Example 1, a lithium core; a coating film of lithium carbide (thickness 8 nm) coating the surface of the lithium; a coating film of lithium carbonate (thickness 63 nm) coating the surface of the lithium carbide; and a coating film present on the surface of the lithium carbonate and containing lithium oxide particles (particle size 480 nm). The content of lithium metal was 90 mass %, and the average particle diameter of the lithium powder was 26 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 11

The lithium powder was manufactured in the same way as in Example 1 with the exception that the oxygen gas was supplied at an addition rate of 400 cm³/min for 60 seconds, and that the reaction solution temperature was 240° C. The resultant lithium powder included, as in Example 1, a lithium core; a coating film of lithium carbide (thickness 9 nm) coating the surface of the lithium; a coating film of lithium carbonate (thickness 65 nm) coating the surface of the lithium carbide; and a coating film present on the surface of the lithium carbonate and containing lithium oxide particles (particle size 500 nm). The content of lithium metal was 89 mass %, and the average particle diameter of the lithium powder was 25 μm. The difference in the content of lithium metal before and after storage in the moist atmosphere was small and 3 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 12

The lithium powder was manufactured in the same way as in Example 1 with the exception that the dew point was −65° C., that the reaction solution temperature was 210° C., and that initially carbon dioxide gas was supplied at an addition rate of 155 cm³/min for 550 seconds, and then oxygen gas was supplied at an addition rate of 400 cm³/min for 60 seconds. The resultant lithium powder included, as in Example 1, a lithium core; a coating film of lithium carbide (thickness 3 nm) coating the surface of the lithium; a coating film of lithium carbonate (thickness 230 nm) coating the surface of the lithium carbide; and a coating film present on the surface of the lithium carbonate and containing lithium oxide particles (particle size 510 nm) and lithium hydroxide. The content of lithium metal was 89 mass %, and the average particle diameter of the lithium powder was 23 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 13

The lithium powder was manufactured in the same way as in Example 1 with the exception that the dew point was −65° C., that the reaction solution temperature was 210° C., and that initially carbon dioxide gas was supplied at an addition rate of 155 cm³/min for 453 seconds and then oxygen gas was supplied at an addition rate of 400 cm³/min for 60 seconds. The resultant lithium powder included, as in Example 1, a lithium core; a coating film of lithium carbide (thickness 2 nm) coating the surface of the lithium; a coating film of lithium carbonate (thickness 170 nm) coating the surface of the lithium carbide; and a coating film present on the surface of the lithium carbonate and containing lithium oxide particles (particle size 490 nm) and lithium hydroxide. The content of lithium metal was 90 mass %, and the average particle diameter of the lithium powder was 22 μm. The difference in the content of lithium metal before and after storage in the moist atmosphere was small and 3 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 14

The lithium powder was manufactured in the same way as in Example 1 with the exception that the dew point was −65° C., that the reaction solution temperature was 210° C., and that initially carbon dioxide gas was supplied at an addition rate of 155 cm³/min for 348 seconds and then oxygen gas was supplied at an addition rate of 400 cm³/min for 60 seconds. The resultant lithium powder included, as in Example 1, a lithium core; a coating film of lithium carbide (thickness 1 nm) coating the surface of the lithium; a coating film of lithium carbonate (thickness 110 nm) coating the surface of the lithium carbide; and a coating film present on the surface of the lithium carbonate and containing lithium oxide particles (particle size 520 nm) and lithium hydroxide. The content of lithium metal was 91 mass %, and the average particle diameter of the lithium powder was 25 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 15

The lithium powder was manufactured in the same way as in Example 1 with the exception that the dew point was −65° C., that the reaction solution temperature was 210° C., and that initially carbon dioxide gas was supplied at an addition rate of 155 cm³/min for 240 seconds and then oxygen gas was supplied at an addition rate of 400 cm³/min for 60 seconds. The resultant lithium powder included, as in Example 1, a lithium core; a coating film of lithium carbide (thickness 3 nm) coating the surface of the lithium; a coating film of lithium carbonate (thickness 60 nm) coating the surface of the lithium carbide; and a coating film present on the surface of the lithium carbonate and containing lithium oxide particles (particle size 540 nm) and lithium hydroxide. The content of lithium metal was 96 mass %, and the average particle diameter of the lithium powder was 21 μm. The difference in the content of lithium metal before and after storage in the moist atmosphere was small and 3 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 16

The lithium powder was manufactured in the same way as in Example 1 with the exception that the dew point was −65° C., that the reaction solution temperature was 210° C., and that initially carbon dioxide gas was supplied at an addition rate of 155 cm³/min for 120 seconds and then oxygen gas was supplied at an addition rate of 400 cm³/min for 60 seconds. The resultant lithium powder included, as in Example 1, a lithium core; a coating film of lithium carbide (thickness 3 nm) coating the surface of the lithium; a coating film of lithium carbonate (thickness 30 nm) coating the surface of the lithium carbide; and a coating film present on the surface of the lithium carbonate and containing lithium oxide particles (particle size 500 nm) and lithium hydroxide. The content of lithium metal was 97 mass %, and the average particle diameter of the lithium powder was 23 μm. The difference in the content of lithium metal before and after storage in the moist atmosphere was small and 2 mass %. Thus, even after the lithium powder was stored in the moist atmosphere, the decrease in the content of lithium metal in the lithium powder was small. This indicates that the lithium powder of the present example has an excellent atmospheric storage characteristic.

### Example 17

The lithium powder was manufactured in the same way as in Example 1 with the exception that the dew point was −65° C., that the reaction solution temperature was 210° C., and that initially carbon dioxide gas was supplied at an addition rate of 155 cm³/min for 60 seconds and then oxygen gas was supplied at an addition rate of 400 cm³/min for 60 seconds. The resultant lithium powder included, as in Example 1, a lithium core; a coating film of lithium carbide (thickness 2 nm) coating the surface of the lithium; a coating film of lithium carbonate (thickness 10 nm) coating the surface of the lithium carbide; and a coating film present on the surface of the lithium carbonate and containing lithium oxide particles (particle size 490 nm) and lithium hydroxide. The content of lithium metal was 98 mass %, and the average particle diameter of the lithium powder was 27 μm. The difference in the content of lithium metal before and after storage in the moist atmosphere was small and 1 mass %. Thus, even after the lithium powder was stored in the moist atmosphere, the decrease in the content of lithium metal in the lithium powder was small. This indicates that the lithium powder of the present example has an excellent atmospheric storage characteristic.

### Comparative Example 1

The lithium powder was manufactured in the same way as in Example 1 with the exception that no oxygen gas was supplied. The resultant lithium powder included a lithium core, and a coating film of lithium carbonate (thickness 60 nm) coating the surface of the lithium. The content of lithium metal was 90 mass %, and the average particle diameter of the lithium powder was 26 μm. The difference in the content of lithium metal before and after storage in the moist atmosphere was large and 12 mass %. Thus, after the lithium powder was stored in the moist atmosphere, the content of lithium metal in the lithium powder was greatly decreased. This indicates that the lithium powder of the present comparative example does not have an excellent atmospheric storage characteristic.

### Comparative Example 2

The lithium powder was manufactured in the same way as in Example 1 with the exception that initially oxygen gas was supplied at an addition rate of 55 cm³/min for 60 seconds and then carbon dioxide gas was supplied at an addition rate of 155 cm³/min for 240 seconds. The resultant lithium powder included a lithium core; a coating film (thickness 115 nm) of lithium oxide coating the surface of the lithium; and a coating film present on the surface of the lithium oxide and containing lithium carbonate particles (particle size 61 nm). The content of lithium metal was 91 mass %, and the average particle diameter of the lithium powder was 25 μm. The difference in the content of lithium metal before and after storage in the moist atmosphere was large and 11 mass %. Thus, after the lithium powder was stored in the moist atmosphere, the content of lithium metal in the lithium powder was greatly decreased. This indicates that the lithium powder of the present comparative example does not have an excellent atmospheric storage characteristic.

### Example 18

### <Fabrication of Negative Electrode>

Ten grams of SiOₓ, 0.231 g of carbon black (DAB50 from Denki Kagaku Kogyo Co., Ltd.), and 7.584 g of 15 mass % aqueous solution of polyacrylic acid binder were weighed into a resin container and mixed in a planetary centrifugal mixer (from Keyence Corporation under the trade name Hybrid Mixer). In this way, a negative electrode paint was fabricated. The negative electrode paint was applied to a current collector copper foil (width 99 mm, thickness 10 μm) by doctor blade method. The negative electrode paint was then dried at 110° C. In this way, a negative electrode having on one side a negative electrode mixture layer was fabricated. The copper current collector had been provided with a portion to which no paint is applied so as to weld an external lead-out terminal. The negative electrode paint was similarly applied to the other side. In this way, a negative electrode having the negative electrode mixture layer on both sides was fabricated. The negative electrode was subjected to heat treatment under a vacuum atmosphere at 150° C. for 20 hours. Then, the negative electrode was pressed using a roll press so as to have a predetermined density.

### <Measurement of Negative Electrode Irreversible Capacity>

The negative electrode mixture on one side of the negative electrode fabricated as described above was removed, and the negative electrode was further punched out into a predetermined shape having a portion for welding an external lead-out electrode. In addition, a copper foil for affixing a lithium foil was prepared. The copper foil was punched out into a predetermined shape having a portion for welding the external lead-out electrode. The negative electrode, the separator (polyethylene microporous film), the lithium foil (thickness 100 μm), and the copper foil were prepared and, in this order, stacked. The negative electrode mixture of the negative electrode and the lithium foil were arranged to oppose each other across the separator. To the negative electrode and the copper foil, external lead-out terminals of nickel foil (width 4 mm, length 40 mm, thickness 100 μm) were welded, respectively, by ultrasonic welding.

In order to enhance the sealing between the external terminals and the case, the external lead-out terminals were wrapped with polypropylene film, including a grafted anhydrous maleic acid, which was thermally adhered. A battery case for encapsulating the battery elements consisting of the stacked body of the negative electrode, separator, lithium foil, and copper foil included an aluminum laminate material. The material had a configuration of polyethylene terephthalate (thickness 12 μm)/aluminum (thickness 40 μm)/polypropylene (thickness 50 μm). The battery case was made into a bag with the polypropylene on the inside. Into the case, the battery elements were inserted and an appropriate amount of electrolyte was added. The case was further vacuum-sealed, and a so-called half cell was fabricated.

As the electrolyte, a mixture solvent of fluoroethylene carbonate (FEC) and diethyl carbonate (DEC) (FEC:DEC=30:70 vol %) in which LiPF6 had been dissolved to 1 M (M=moldm⁻³) was used. The half cell was charged with an current of 0.05 C to 5 mV, and then discharged to 2 V. The charge/discharge capacities in this case are referred to as a first cycle charge capacity and a first cycle discharge capacity, respectively. The irreversible capacity was determined according to the following expression (8).

Irreversible capacity (mAh)=First cycle charge capacity (mAh)−first cycle discharge capacity (mAh) (8)

The C rate notation is described. The nC (mA) is an current with which a nominal capacity (mAh) can be charged/discharged in 1/n(h). For example, if the battery has a nominal capacity of 70 mAh, the 0.05 C current is 3.5 mA (calculating formula: 70×0.05=3.5).

### <Fabrication of Pre-Dope Negative Electrode>

On both sides of the negative electrode fabricated as described above in paragraph (0124), the lithium powder manufactured in Example 1 was dispersed. The negative electrode was then pressurized at 20 kN using a hand press to immobilize the lithium powder on the negative electrode. The negative electrode is referred to as a pre-dope negative electrode. The amount of lithium powder dispersed per unit area is an amount corresponding to a mass equivalent to the irreversible capacity per unit area on one side of the negative electrode. The dispersed amount was determined according to the following expression (9).

Dispersed amount (g/cm²)×3862 mAh/g×content of lithium metal before storage (%)/100=irreversible capacity (mAh/cm²) (9)

### <Fabrication of Positive Electrode>

As the positive electrode active material, 85 g of LiNi_{0.8}Co_{0.15}Al_{0.05}O₂, 5 g of carbon black (DAB50 from Denki Kagaku Kogyo Co., Ltd.), and 5 g of graphite (from Timcal under the trade name KS-6), and a polyvinylidene fluoride (PVDF) solution of 50 g of binder (from Kureha Corp. under the trade name KF7305, which is a NMP solution containing 5 mass % of PVDF) were weighed into a resin container, and mixed using the Hybrid Mixer. In this way, a positive electrode paint was fabricated. The positive electrode paint was applied to a current collector aluminum foil (thickness 20 μm) by doctor blade method. The positive electrode paint was then dried at 110° C. In this way, a positive electrode having on one side a positive electrode mixture layer was fabricated. The aluminum current collector had been provided with a portion to which no positive electrode paint is applied so as to weld an external lead-out terminal. The other side was also similarly applied with the positive electrode paint. In this way, a positive electrode having the positive electrode mixture layer on both sides was fabricated. The positive electrode was then pressed using a roll press so as to have a predetermined density.

### <Fabrication of Battery>

The pre-dope negative electrode, the positive electrode, and the separator (polyethylene microporous film) fabricated as mentioned above were prepared and cut into predetermined dimensions. The positive electrode, the separator, and the pre-dope negative electrode, in this order, were then stacked to obtain a stacked body. The stacked body was fixed with a tape to avoid the positive electrode, the separator, and the negative electrode being displaced from one another. To the positive electrode and the negative electrode, the external lead-out terminals of aluminum foil (width 4 mm, length 40 mm, thickness 100 μm) and nickel foil (width 4 mm, length 40 mm, thickness 100 μm), respectively, were welded by ultrasonic welding. In order to enhance the sealing between the external terminals and the case, the external lead-out terminals were wrapped with a polypropylene film, including a grafted carboxylic acid anhydride, which was thermally adhered.

A battery case for encapsulating the battery elements consisting of the stacked body of the positive electrode, negative electrode, and separator included an aluminum laminate material. The material had a configuration of polyethylene terephthalate (thickness 12 μm)/aluminum (thickness 40 μm)/polypropylene (thickness 50 μm). The battery case was made into a bag with the polypropylene on the inside. Into the case, the battery elements were inserted, and an appropriate amount of electrolyte was added. The electrolyte was a mixture solvent of FEC and DEC (FEC:DEC=30:70 vol %) having LiPF6 dissolved therein to 1 M (M=moldm⁻³). The case was thereafter vacuum-sealed, and a lithium ion secondary battery was fabricated.

### (Battery Test Method)

In order to evaluate the lithium ion secondary battery fabricated as described above, a charge/discharge cycle test was implemented. The charge/discharge test was performed in a constant temperature bath at 25° C. With regard to charge/discharge cycle test conditions, in the first cycle, charging was implemented at 0.05 C for three hours. Thereafter, CCCV charging was implemented at 0.2 C to 4.2 V. Discharging was implemented at 0.2 C to 3.0 V. In the second cycle and thereafter, CCCV charging was implemented at 0.5 C to 4.2 V. Further, discharging was implemented at 1 C to 3.0 V. The CCCV charging is a charge method as follows. Initially, charging is implemented with a predetermined constant current to a predetermined voltage. After the predetermined voltage is reached, charging is implemented until the current is decreased to a predetermined current. In the present charge/discharge cycle test, the predetermined current was 0.05 C. The charge/discharge cycle test was repeated for 500 cycles.

With respect to a value 100 of the first cycle discharge capacity, the discharge capacity after 500 cycles is normalized. A value obtained by the normalization is considered the capacity retention. The capacity retention is shown in Table 3. As shown in Table 3, the examples exhibited higher capacity retentions than the comparative examples. It is believed that this is due to the atmospheric storage stability of the lithium powder. With the lithium powders according to the examples having excellent atmospheric storage stability, the chemical species as a cause of irreversible capacity and lithium can be sufficiently electrochemically reacted with each other. On the other hand, it is believed that in the case of the lithium powders with less storage stability, it is difficult to cause the chemical species as a cause of irreversible capacity and lithium to sufficiently electrochemically react with each other.

### Examples 19 to 34 and Comparative Examples 3 and 4

Lithium ion secondary batteries according to Examples 19 to 34 and Comparative Examples 3 to 4 were fabricated in the same way as in Example 18 with the exception that, as the lithium powder dispersed on the negative electrode mixture layer, the lithium powders obtained in Examples 2 to 17 and Comparative Examples 1 to 2 were used. The lithium ion secondary batteries were subjected to the charge/discharge cycle test.

TABLE 1

| | Manufacturing conditions | | | |
|---|---|---|---|---|
| | | Carbon | | Reaction |
| | | dioxide | Oxygen gas | solution |
| | | gas supply | supply | temperature/ |
| | Dew point/° C. | amount/cm³ | amount/cm³ | ° C. |
| Example 1 | −99 | 620 | 1 | 185 |
| Example 2 | −99 | 620 | 12 | 185 |
| Example 3 | −99 | 620 | 55 | 185 |
| Example 4 | −99 | 620 | 400 | 185 |
| Example 5 | −99 | 620 | 700 | 185 |
| Example 6 | −99 | 620 | 1300 | 185 |
| Example 7 | −99 | 620 | 400 | 200 |
| Example 8 | −99 | 620 | 400 | 210 |
| Example 9 | −99 | 620 | 400 | 220 |
| Example 10 | −99 | 620 | 400 | 230 |
| Example 11 | −99 | 620 | 400 | 240 |
| Example 12 | −65 | 1420 | 400 | 210 |
| Example 13 | −65 | 1170 | 400 | 210 |
| Example 14 | −65 | 900 | 400 | 210 |
| Example 15 | −65 | 620 | 400 | 210 |
| Example 16 | −65 | 310 | 400 | 210 |
| Example 17 | −65 | 155 | 400 | 210 |
| Comparative | −99 | 620 | 0 | 185 |
| Example 1 | | | | |
| Comparative | −99 | 620 | 55 | 185 |
| Example 2 | | | | |

TABLE 2

| | | Li | Thickness of each coating film/nm | | | | | | |
|---|---|---|---|---|---|---|---|---|---|
| | | content | First | | | | | Li content | Difference |
| | | before | coating | | | | | after | in Li content |
| | D50/ | storage/ | film | Second coating film | | | | storage/ | before/after |
| | μm | mass % | Li₂C₂ | Li₂CO₃ | LiOH | Li₂O | Total | mass % | storage/mass % |
| Example 1 | 25 | 90 | ND | 58 | ND | 1 | 59 | 89 | 1 |
| Example 2 | 22 | 92 | ND | 60 | ND | 10 | 70 | 90 | 2 |
| Example 3 | 26 | 90 | ND | 63 | ND | 115 | 178 | 87.5 | 2.5 |
| Example 4 | 25 | 89 | ND | 62 | ND | 530 | 592 | 85 | 4 |
| Example 5 | 26 | 88 | ND | 65 | ND | 1100 | 1165 | 83 | 5 |
| Example 6 | 28 | 87 | ND | 60 | ND | 2000 | 2060 | 81 | 6 |
| Example 7 | 22 | 90 | 1 | 62 | ND | 500 | 562 | 86 | 4 |
| Example 8 | 23 | 92 | 3 | 60 | ND | 510 | 570 | 87 | 5 |
| Example 9 | 21 | 91 | 5 | 61 | ND | 520 | 581 | 86 | 5 |
| Example 10 | 26 | 90 | 7 | 63 | ND | 480 | 543 | 85 | 5 |
| Example 11 | 25 | 89 | 9 | 65 | ND | 500 | 565 | 84 | 5 |
| Example 12 | 23 | 89 | 3 | 230 | Detected | 510 | 740 | 84 | 5 |
| Example 13 | 22 | 90 | 2 | 170 | Detected | 490 | 660 | 86 | 4 |
| Example 14 | 25 | 91 | 1 | 110 | Detected | 520 | 630 | 87 | 4 |
| Example 15 | 21 | 96 | 3 | 60 | Detected | 540 | 600 | 91.5 | 4.5 |
| Example 16 | 23 | 97 | 3 | 30 | Detected | 500 | 530 | 92 | 5 |
| Example 17 | 27 | 98 | 2 | 10 | Detected | 490 | 500 | 94 | 4 |
| Comparative | 26 | 90 | ND | 60 | ND | ND | 60 | 78 | 12 |
| Example 1 | | | | | | | | | |
| Comparative | 25 | 91 | ND | 61 | ND | 115 | 176 | 80 | 11 |
| Example 2 | | | | | | | | | |

Note:
ND means “not detected”.

TABLE 3

| | Capacity |
|---|---|
| | retention/% |
| Example 18 | 85 |
| Example 19 | 83 |
| Example 20 | 82 |
| Example 21 | 80 |
| Example 22 | 77 |
| Example 23 | 70 |
| Example 24 | 77 |
| Example 25 | 78 |
| Example 26 | 79 |
| Example 27 | 77 |
| Example 28 | 78 |
| Example 29 | 79 |
| Example 30 | 77 |
| Example 31 | 78 |
| Example 32 | 78 |
| Example 33 | 79 |
| Example 34 | 78 |
| Comparative | 51 |
| Example 3 | |
| Comparative | 50 |
| Example 4 | |

The technology of the present disclosure is not limited to the embodiment, which is merely exemplary. All configurations that are substantially identical to the technical concepts set forth in the claims, and all configurations that provide operations or effects similar to those of the technical concepts set forth in the claims are intended to be embraced therein.

The present embodiment provides a lithium powder having excellent atmospheric storage stability, and a lithium ion secondary battery negative electrode and a lithium ion secondary battery in which the lithium powder is used and which have excellent cycle characteristic. They may be preferably applied in a power supply for portable electronic devices, and may also be applied in electric vehicles and household and industrial storage batteries.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A lithium powder comprising:
a core of metallic lithium; and
a coating layer coating a surface of at least a part of the core, wherein the coating layer contains lithium carbonate including a surface in at least a part of which lithium oxide is present.

2. The lithium powder according to claim 1, wherein
the coating layer includes a first coating film layer present in at least a part of the core, and a second coating film layer present in a surface of the first coating film layer,
the first coating film layer contains lithium carbide, and
the second coating film layer contains lithium carbonate.

3. The lithium powder according to claim 2, wherein the second coating film layer contains lithium hydroxide.

4. The lithium powder according to claim 1 having a lithium content in a range of from 80 to 98 mass %.

5. The lithium powder according to claim 2, wherein the second coating film layer has a thickness in a range of from 59 nm to 2060 nm.

6. The lithium powder according to claim 2, wherein the first coating film layer has a thickness in a range of from 1 nm to 10 nm.

7. The lithium powder according to claim 1, wherein the lithium oxide is a particle having a particle size in a range of from 1 nm to 2000 nm.

8. The lithium powder according to claim 1, wherein the lithium oxide has a form of a layer having a thickness in a range of from 1 nm to 2000 nm.

9. A lithium ion secondary battery negative electrode comprising a lithium ion doped with the lithium powder according to claim 1.

10. A lithium ion secondary battery comprising the lithium ion secondary battery negative electrode according to claim 9, an electrolyte, and a positive electrode.
